(19) United States
(12) Patent Application Publication
(10) Pub. No.: US 2018/0013175 A1
(43) Pub. Date: Jan. 11, 2018

(54) BATTERY BOX OF ELECTRONIC CIGARETTE

(71) Applicant: Tuanfang LIU, Ji'an (CN)

(72) Inventor: Tuanfang LIU, Ji'an (CN)

(21) Appl. No.: 15/362,724

(22) Filed: Nov. 28, 2016

(30) Foreign Application Priority Data
Jul. 9, 2016 (CN) 201610535762.0

(51) Int. Cl. H01M 10/42; A24F 47/00; H02J 7/00

(52) U.S. Cl. CPC H01M 10/425; H02J 7/0052; A24F 47/008; H01M 2010/4271; H02J 2007/0062; H01M 2220/30

(57) ABSTRACT

A battery box of an electronic cigarette including a main body having a first magnet, a press block, a battery cover, an electrode sleeve, a first insulating ring, a second insulating ring, a connector fixing member, a first spring, an elastic electrode connector, a connector positioning member, a second spring, a positive spring plate, a spring plate carrier, a control board, a first screw, a power button, a first silicon sleeve, a regulation button, and a second silicon sleeve. The first magnet is embedded in a slot of the main body via the press block. The main body includes a screw thread on the top of the main body. The battery cover is connected to the main body. The control board is mounted on the main body. The first silicon sleeve is sleeved on the power button, and the second silicon sleeve is sleeved on the regulation button.

### CROSS-REFERENCE TO RELATED APPLICATIONS

Pursuant to 35 U.S.C. §119 and the Paris Convention Treaty, this application claims the benefit of Chinese Patent Application No. 201610535762.0 filed Jul. 9, 2016, the contents of which, including any intervening amendments thereto, are incorporated herein by reference.

### BACKGROUND OF THE INVENTION

### Field of the Invention

The invention relates to a battery box of an electronic cigarette.

### Description of the Related Art

Typically, a battery box of an electronic cigarette has three buttons, which is insufficient for complex key operations. In addition, the USB charging interface of the battery box is unidirectional, which is inconvenient for use.

### SUMMARY OF THE INVENTION

In view of the above-described problems, it is one objective of the invention to provide a battery box of electronic cigarette. The battery box has five buttons and the USB charging interface thereof is nondirectional.

To achieve the above objective, in accordance with one embodiment of the invention, there is provided a battery box of electronic cigarette, comprising a main body, a first magnet of the main body, a press block, a battery cover, an electrode sleeve, a first insulating ring, a second insulating ring, a connector fixing member, a first spring, an elastic electrode connector, a connector positioning member, a second spring, a positive spring plate, a spring plate carrier, a control board, a first screw, a power button, a first silicon sleeve, a regulation button, a second silicon sleeve, a cover board of the regulation button, a second screw, and a second magnet of battery cover. The first magnet is embedded in a slot of the main body via the press block. The main body is stainless steel, and a surface of the main body is finished. The main body comprises a standard 510 screw thread on a top of the main body. The battery cover is connected to the main body under an effect of magnetic attraction. The electrode sleeve, the first insulating ring, the second insulating ring, and the connector fixing member are sheathed in, and are compressed in the main body. The first spring is sleeved on the elastic electrode connector and is connected to the connector positioning member. The first spring, the elastic electrode connector, and the connector positioning member are compressed in the main body. When the battery box is connected to various kinds of atomizers, the electrical contact is well, and short circuit is effectively avoided. The second spring is disposed in the positive spring sheet, and the positive spring sheet is compressed in the spring plate carrier. The spring plate carrier with the positive spring sheet is inserted in a hole on the control board, and is soldered to the control board. A charging interface on the control board is a Type C interface. A printed circuit board on the control board comprises a main control IC unit and a control circuit. The main control IC unit is connected to battery, display member, and the control circuit. The control circuit is adapted to control atomizer output. The main IC unit is connected to buttons and charging circuit. The charging circuit is connected to the battery. The control board is mounted on the main body via the first screw. The first silicon sleeve is sleeved on the power button, and the second silicon sleeve is sleeved on the regulation button. The power button and the regulation button are mounted on the cover board of the regulation button. A screw post on the cover board of the regulation button is aligned with a hole on the control board, and the cover board of the regulation button is mounted on the main body via the second screw. The second magnet is embedded in a slot of the battery cover, and is riveted with the battery cover via the press block. The battery cover is stainless steel, and a surface of the battery cover is finished. The battery cover is a foolproof structure. The main body is connected to the battery cover under the effect of magnetic attraction, thus the battery is conveniently loaded.

In a preferred embodiment of the invention, the battery box comprises five buttons. The five buttons have corresponding functions, and in use, the user press the buttons to switch among the functional modes.

In a preferred embodiment of the invention, the battery box comprises a safety lock. The safety lock is changed or locked via a three-digit password, thus operation or smoking is invalid when the battery box is out of sight of the user.

In a preferred embodiment of the invention, the battery box is named using ten lower and upper case letters on the battery box. The battery box is renamed through a connection to a computer; or during smoking, the battery box is renamed via the buttons on the battery box without a connection to a computer, thus the battery box is convenient to use.

In a preferred embodiment of the invention, the battery box comprises a power regulation module, and the power is regulated in accordance with different functional modes.

In a preferred embodiment of the invention, the battery box comprises a protection module. The protection module is adapted to regulate the working mode and protect the atomizer when the user chooses the wrong smoking mode. Following atomizer replacement, the protection module is adapted to automatically regulate the working mode in accordance with an atomizer resistance variation and lower the power when the working mode of the atomizer is wrongly chosen.

Advantage of the battery box according to embodiments of the invention is that the battery box is convenient to use.

### BRIEF DESCRIPTION OF THE DRAWINGS

The invention is described hereinbelow with reference to the accompanying drawings, in which:

FIG. 1 is a stereogram of a battery box of electronic cigarette comprising five buttons in accordance with one embodiment of the invention;

FIG. 2 is an exploded view of a battery box of electronic cigarette comprising five buttons in accordance with one embodiment of the invention;

FIG. 3 is a first cross-sectional view of a battery box of electronic cigarette comprising five buttons in accordance with one embodiment of the invention;

FIG. 4 is a second cross-sectional view of a battery box of electronic cigarette comprising five buttons in accordance with one embodiment of the invention;

FIG. 5 is a circuit diagram of a control board of a battery box comprising five buttons in accordance with one embodiment of the invention;

FIG. 6 is a first flow chart of a battery box of electronic cigarette comprising five buttons in accordance with one embodiment of the invention;

FIG. 7 is a second flow chart of a battery box of electronic cigarette comprising five buttons in accordance with one embodiment of the invention; and

FIG. 8 is a third flow chart of a battery box of electronic cigarette comprising five buttons in accordance with one embodiment of the invention.

### DETAILED DESCRIPTION OF THE EMBODIMENTS

For further illustrating the invention, experiments detailing a battery box of electronic cigarette are described below. It should be noted that the following examples are intended to describe and not to limit the invention.

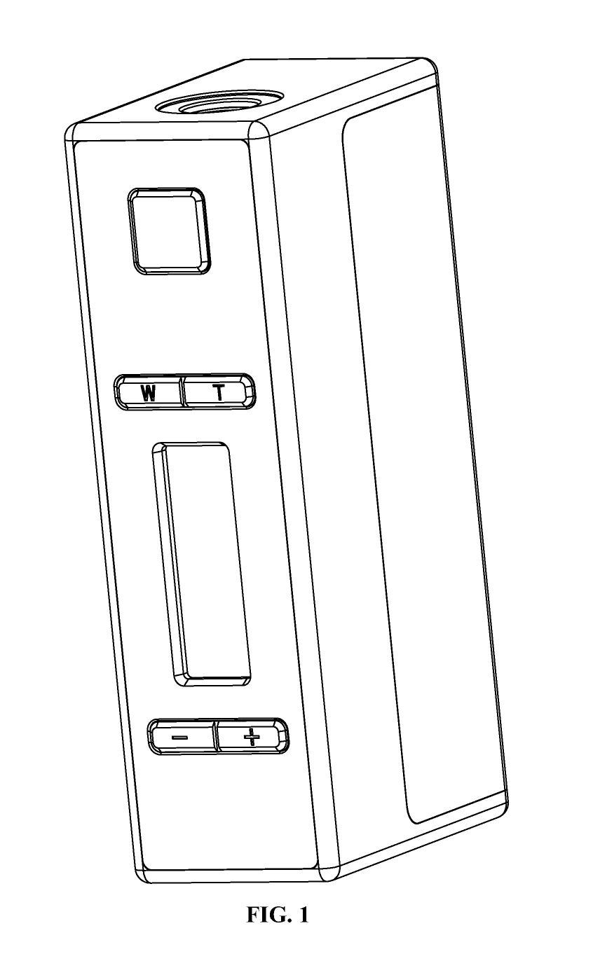

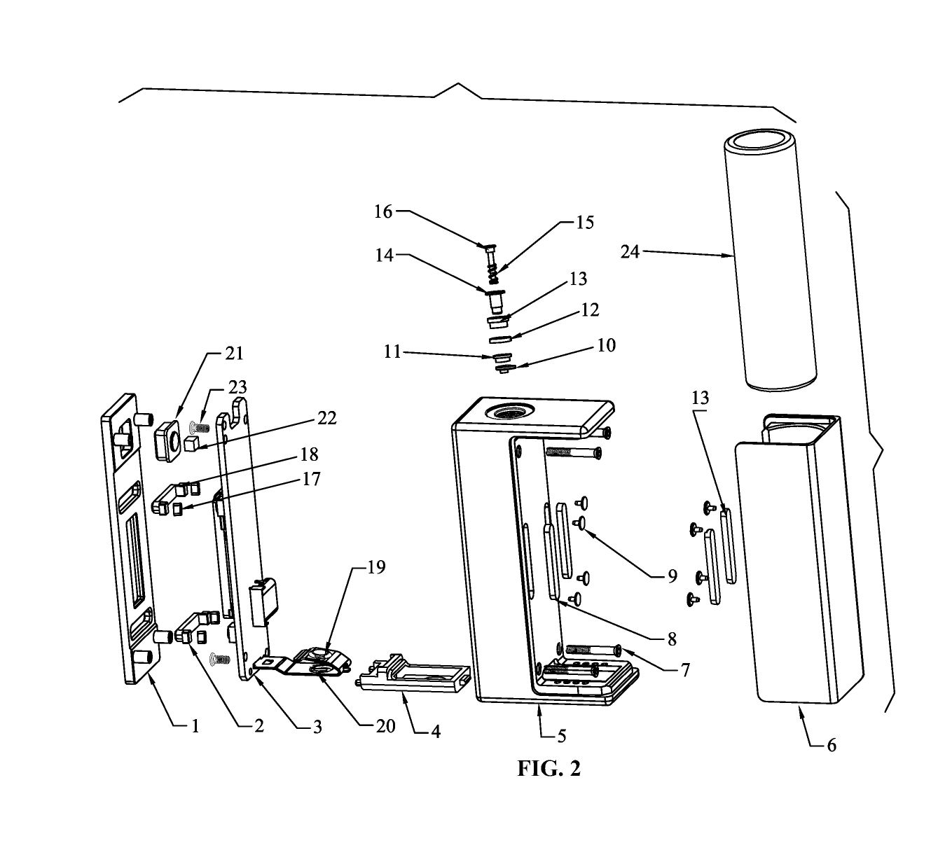

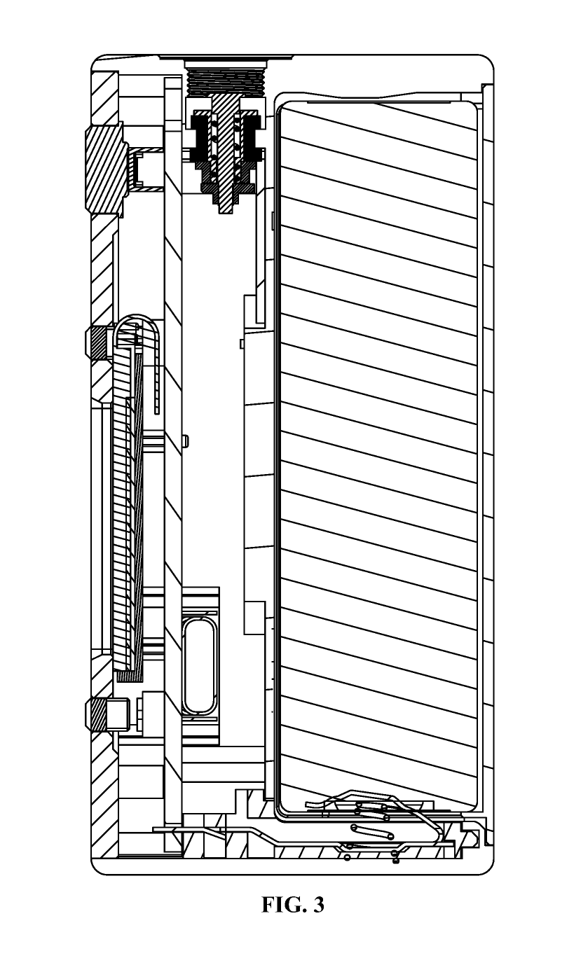

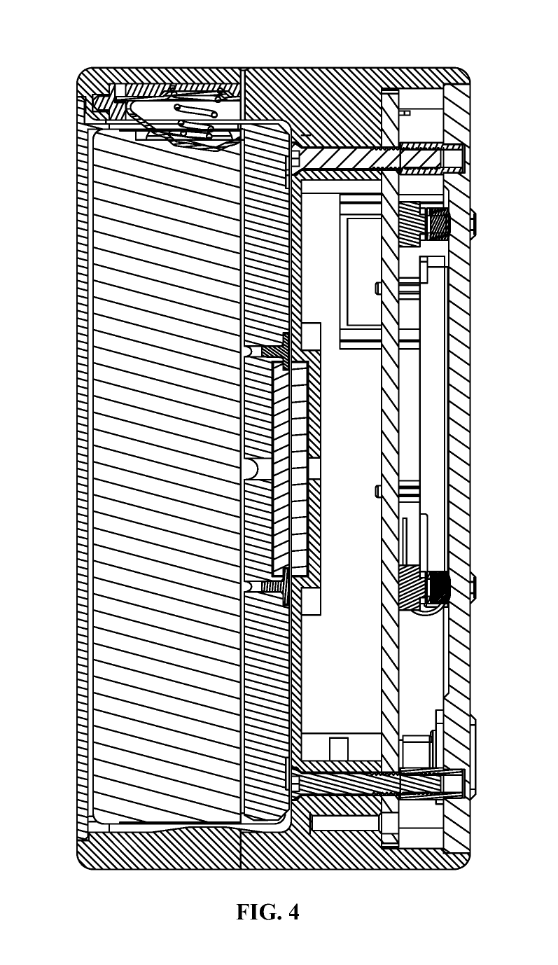

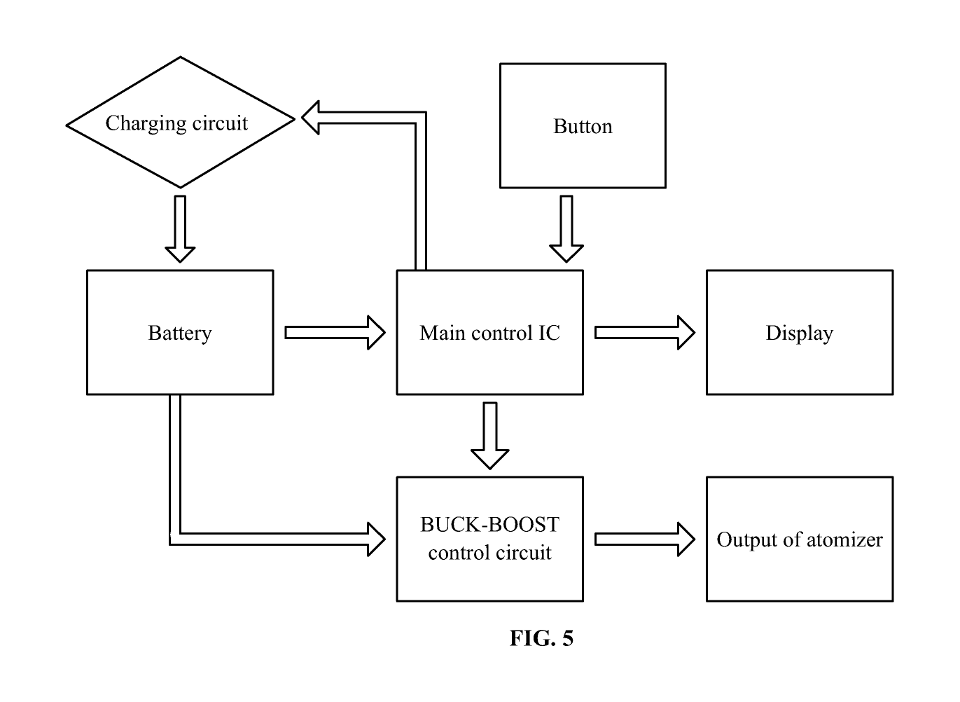

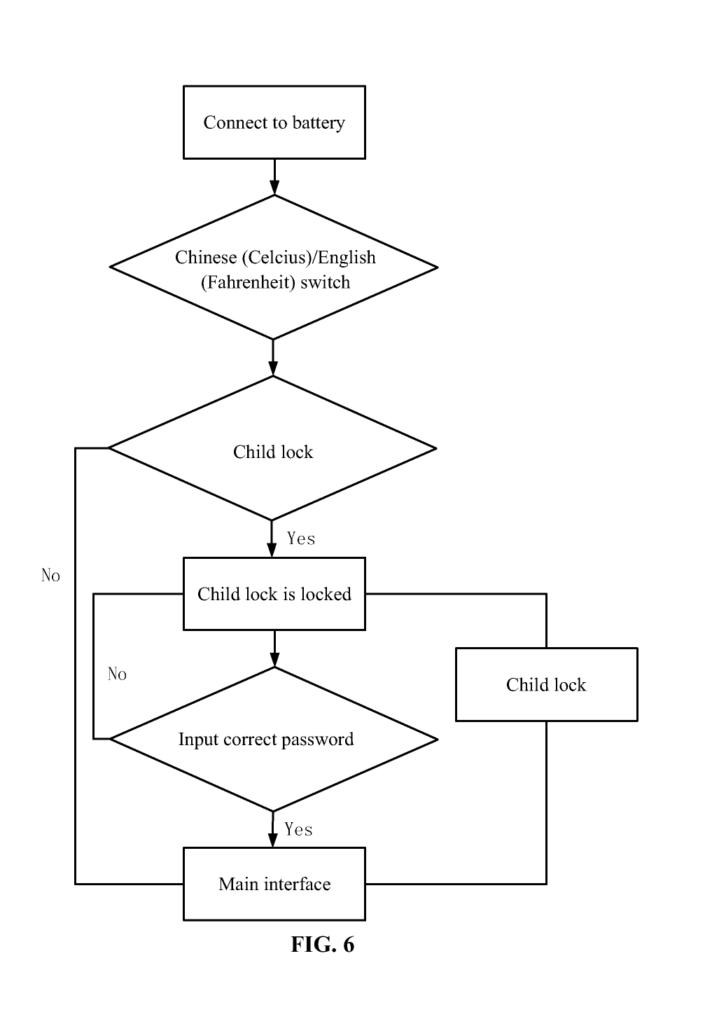

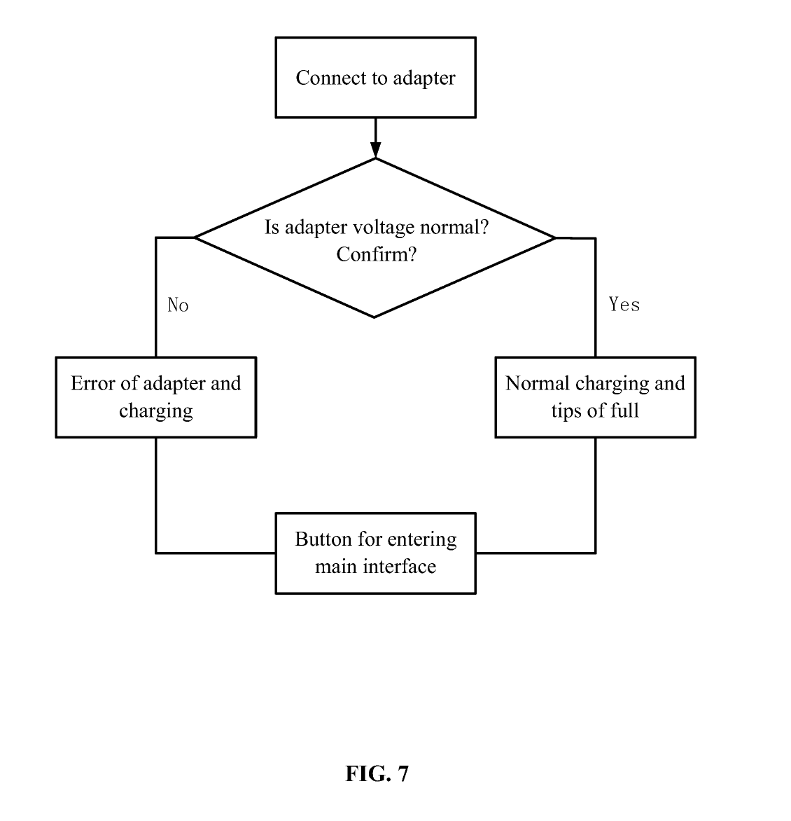

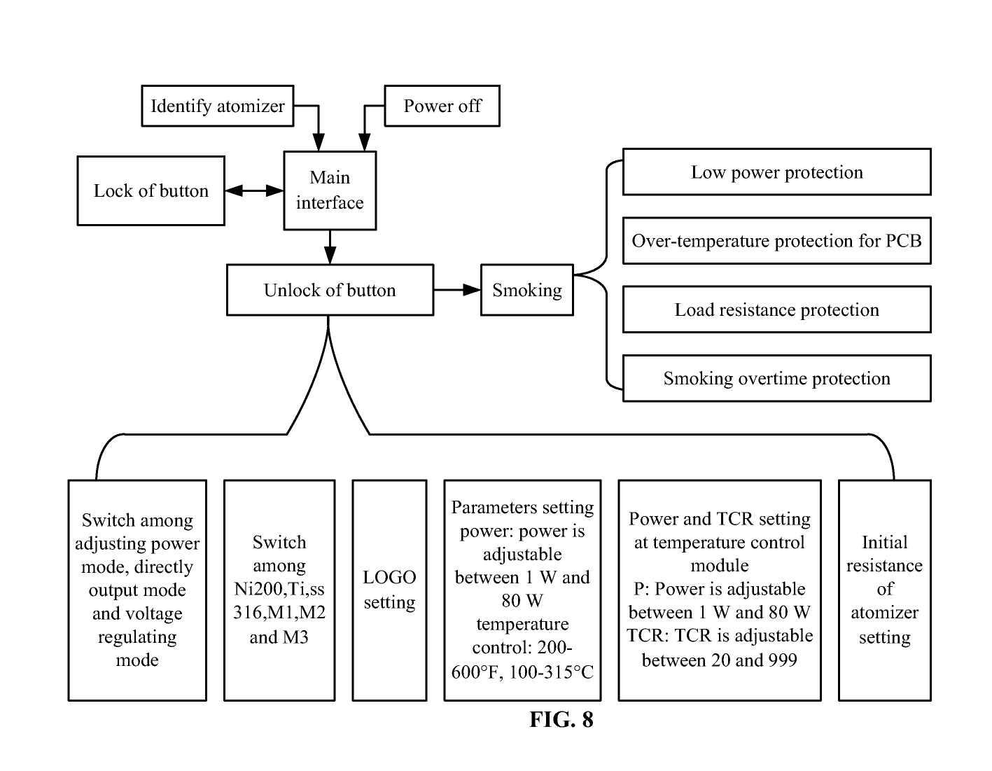

As shown in FIGS. 1-8, a battery box of electronic cigarette comprising buttons comprises a main body 5. The first magnet 8 is embedded in a slot of the main body 5 via the press block 9. The main body 5 is stainless steel, and a surface of the main body is finished. The main body 5 comprises a standard 510 screw thread which can be adapted to various atomizers on a top of the main body. The battery cover 6 is connected to the main body 5 under an effect of magnetic attraction. The electrode sleeve 14, the first insulating ring 13, the second insulating ring 12, and the connector fixing member 11 are sheathed in, and are compressed in the main body 5. The first spring 15 is sleeved on the elastic electrode connector 16 and is connected to the connector positioning member 10. The first spring, the elastic electrode connector, and the connector positioning member are compressed in the main body 5. When the battery box is connected to various kinds of atomizers, the electrical contact is well, and short circuit is effectively avoided. The second spring 20 is disposed in the positive spring sheet 19, and the positive spring sheet is compressed in the spring plate carrier 4. The spring plate carrier 4 with the positive spring sheet 19 is inserted in a hole on the control board 3, and is soldered to the control board. A charging interface on the control board 3 is a Type C interface, and the charging wire can be inserted to the interface without considering the direction, thus the charging is convenient. The control board 3 is mounted on the main body 5 via the first screw 23, thus the battery box is unlikely to get loose when vibration happens or the battery box falls down. In addition, the first silicon sleeve 22 is sleeved on the power button 21, and the second silicon sleeve 17 is sleeved on the regulation button 2. The power button and the regulation button are mounted on the cover board of the regulation button 1. The first silicon sleeve 22 and the second silicon sleeve 17 make it comfortable for users to press the buttons. In addition, a screw post on the cover board of the regulation button 1 is aligned with a hole on the control board 3, and the cover board of the regulation button is mounted on the main body 5 via the second screw 7. The second magnet 25 is embedded in a slot of the battery cover 6, and is riveted with the battery cover via the press block 9. The battery cover 6 is stainless steel, and a surface of the battery cover is finished. The 18605 battery cell 24 is free to be disposed in the battery cover, and the insulation layer on the outer layer of the battery cell is unlikely to be damaged. The battery cover 6 is a foolproof structure. The battery cover is unable to be mounted on the main body 5 from the wrong direction. The main body 5 is connected to the battery cover 6 under the effect of magnetic attraction, thus the battery is conveniently loaded.

Specifically, a printed circuit board on the control board 3 comprises a main control IC unit and a control circuit. The main control IC unit is connected to battery, display member, and the control circuit. The control circuit is adapted to control atomizer output. The main IC unit is connected to buttons and charging circuit. The charging circuit is connected to the battery. The control board 3 is mounted on the main body 5 via the first screw 23. the first silicon sleeve 22 is sleeved on the power button 21, and the second silicon sleeve 17 is sleeved on the regulation button 2. The power button and the regulation button are mounted on the cover board of the regulation button 1. A screw post on the cover board of the regulation button 1 is aligned with a hole on the control board 3, and the cover board of the regulation button is mounted on the main body 5 via the second screw 7. The second magnet 25 is embedded in a slot of the battery cover 6, and is riveted with the battery cover via the press block 9. The battery cover 6 is stainless steel, and a surface of the battery cover is finished. The battery cover 6 is a foolproof structure. The main body 5 is connected to the battery cover 6 under the effect of magnetic attraction, thus the battery is conveniently loaded.

A charging interface is a novel Type C interface which is applied to data transmission and large current charge, and the charging wire can be inserted to the interface without considering the direction. The transmission and the charge are fast. The charging current reaches 2 A. In addition, only the battery box uses five buttons. The five buttons have corresponding functions, and in use, the user press the buttons to switch among the functional modes, thus avoiding constantly choosing in the menu of conventional battery box. The battery box in the invention is simple and convenient to use during smoking.

In terms of private use and in the aspect of preventing juvenile smoking, the battery box comprises a safety lock. The safety lock is changed or locked via a three-digit password, thus operation or smoking is invalid when the battery box is out of sight of the user.

In terms of name display in use, the battery box is named using ten lower and upper case letters on the battery box without a connection to a computer. During smoking, the battery box is renamed via the buttons on the battery box when the battery box is disconnected from the computer. Thus the battery box is convenient to use.

The battery box comprises a power regulation module, and the power regulation module is adapted to regulate the maximum output power and the maximum duration of a whiff of cigarette at any working mode. When in use, the output power and the maximum duration of a whiff of cigarette can be regulated in accordance with individual preference, thus the battery box in the invention is humanized and is excellent in user experience and health security.

The battery box comprises a protection module which is adapted to automatically regulate the working mode and protect the atomizer when the user chooses the wrong smoking mode. Following atomizer replacement, the protection module is adapted to automatically regulate the working mode in accordance with atomizer resistance variation during smoking and lower the power when the working mode of the atomizer is wrongly chosen, thus the atomizer is under protection when the user operates wrongly.

In the example, the operation steps of the battery box are as follows:

1. Power on

As the battery box is turned on, the stand-by screen appears; after 15 secs, as no button is pressed, the screen is off (no display). The power mode and the temperature control mode follow the last settings.

2. Power off/on

When the battery box is on, press the button M five times in sequence within two secs to turn off the battery box; the OLED screen displays “Locked click5×”, and is off in three secs (no display);

as the battery box is off, press any button to wake the battery box, and the screen displays “Locked Click 5×”; the screen is off in three secs (no display); press the button M for five times in sequence within two secs to turn on the battery box, which is the same as that in step 1.

3. Power or temperature regulation lock

a. When the battery box is on and is stand-by, simultaneously press the button W and the button + for more than two secs to lock the power, the temperature, and the module switch, which is displayed on the OLED screen, thus the power or temperature adjustment is invalid, and the device lock and the safety lock are invalid, only smoking is practicable.

b. When the battery box is on and is locked, simultaneously press the button W and the button + for more than two secs to unlock the power and temperature setting, which is displayed on the OLED screen; and the battery box can be turned on again.

4. Safety lock

a. Simultaneously press the button W and the button − for more than two secs to enter the safety lock password interface; input the password to lock or unlocked the safety lock; the initial password is 000;

move the cursor to the last one “reset”, click OK and input original password to reset; when the password which is input is wrong, “error” flashes on the screen.

b. Move the cursor and choose numbers by pressing button + and button −; press the button M to confirm, after that, the “*” on the screen is changed to be “corresponding number”, and move on to the next “*” automatically; when the three-digit password is correct, the safety lock can be locked or unlocked.

c. As the safety lock is locked, the interface displays: unlock to enter the main interface (and the locking status is saved).

d. As the safety lock is locked, any button except the combination of button W and button − and the five times of button M to turn on/off the battery box is invalid.

e. Reset password: input correct original password to reset the password.

5. LOGO setting

Press the button T and the button − to enter into the main interface and set the LOGO; press button W to delete, and press button T to shift cases; a maximum of ten letters are adaptive and displayed in the neutral position; press button + or button − to choose from letters, and press button M to conform; when the LOGO is conformed, press button T and button − to exit, and save the LOGO.

6. Status switching

a. Regular switch

Turn on the battery box and press button W to switch among the three regular modules: power, voltage, and ByPass; press button W to cyclically switch;

press the button W at the temperature control module to switch to the power module.

b. Temperature control switch

Turn on the battery box and press button T to switch among the six regular modules: Ni200, Ti, SS316, M1, M2, and M3; press button T to switch;

Press the button T at the power module to switch to the temperature control module Ni200.

c. Chinese (Celcius)/English (Fahrenheit) switch

Press the button M to connect to the battery and enter the Chinese/English selection interface; press button + or − to choose, and press button M to confirm;

d. Screen display switch

As the battery box is turned on, turn the screen display 180 degrees in accordance with the direction.

7. Parameters setting

a. When the battery box is on and the screen display is off, press the button + or − the first time to awaken the screen display, and not to add or subtract the parameter.

b. Short press the button + once or the button − once to add or subtract 1° C./1° F./0.1 W; press the button + or − for more than 0.5 secs to continuously add or subtract;

c. Power: the power is adjustable between 1 W and 80 W;

d. Temperature control: (200-600° F., 100-315° C.).

8. Power and TCR setting at temperature control module

Simultaneously press the button T and + to set the maximum power and the TCR at the temperature control module; press the button W to switch among Ni200, Ti, SS316, M1, M2, and M3, and the corresponding smoking type displays colors during switches; press button T to switch among power P and TCR, and the corresponding parameters display colors; then press the button + and − to set up the parameters. At the Ni200, Ti, and SS316 modules, the PCR parameters cannot be changed and are displayed as -.--, and only the maximum power value can be changed; both the power parameters and the PCR parameters can be set up at M1, M2, and M3 modules; when the parameters setting is finished, simultaneously press the button T and + to exit.

P: the power is adjustable between 1 W and 80 W.

TCR: the TCR is adjustable between 20 and 999.

9. Initial resistance of atomizer determining

a. Replace the atomizer when the screen display is on and the atomizer is at room temperature; if the atomizer is replaced at temperature control module, a new atomizer confirmation is shown on the screen, and press button + to confirm the new atomizer so that a new resistance is saved; or press button − to recall the old resistance; if the atomizer is not replaced at temperature control module, switch to the temperature control module, and the confirmation is displayed on the screen.

b. As the resistance is confirmed, output the resistance whether at power module or at temperature control module.

10. Smoking

At stand-by mode, press the button M to start inhaling; the interface is unchanged and the battery box is adapted to directly output.

11. Charging

a. Use a Type-C USB interface, and a charging current is: no higher than 2 A.

b. Connect to the USB to charge the battery; the electricity in the battery runs fast, and when the battery is fully charged, the battery on the screen is full; the electricity rises from the current electricity; when the battery is fully charged, the battery on the screen is full and is always on.

c. The voltage of the battery is VFLOAT=4.2±0.05 V; when the charging current is below 100 mA, stop charging; remove the charger once the battery is fully charged.

d. Connect to the USB plug, if the battery voltage is higher than the threshold value of recharging: VFLOAT-VRECHRG, VRECHRG=0.15±0.05V, the battery is not charged and the battery on the screen is full, for the purpose of prolonging the service life of the battery.

e. Do not replace battery when on charge.

f. Connect to the USB plug to charge the battery, if the battery voltage is lower than 0.5 V, or when the battery is wrongly connected from an opposite side, the screen display is off.

g. Do not remove battery when on charge, because it can cause damage to the battery. Disconnect the USB plug before the battery replacement.

12. Protection function

a. When the inhaling is over 10 secs, the controller works to turn off the atomizer, and the screen displays “Over 10S” for five secs then back to the stand-by screen; and any button is invalid;

the numbers blinks, and the inhaling duration is adjustable between 5 and 15 secs by pressing the buttons.

b. If the atomizer resistance equals 9.99 when the button M is pressed, the screen displays that the battery box returns to the stand-by mode after 3 secs.

c. When the atomizer is short-circuited or the atomizer resistance is lower than 1Ω during smoking, the screen displays that the battery box returns to the stand-by mode after 3 secs.

d. If the battery voltage is lower than 3.2 V when the button M is pressed, the screen displays that the battery box returns to the stand-by mode after 3 secs; during smoking, if the battery voltage is lower than 3.0 V, the power output is reduced; the power is reduced 10 W each time, and the battery voltage is still lower than 2.95 V when the power is below 10 W.

e. Prior to the smoking or during the smoking, if the device is detected to be too hot, the screen displays “TOO HOT” for five secs, and the battery box returns to the stand-by mode.

f. If the voltage of the USB end is lower than 4.2 V when the electronic cigarette is on charge, a warning that the charger should be checked is displayed on the screen.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A battery box of an electronic cigarette, comprising:
a main body comprising a first magnet, a press block, a battery cover, an electrode sleeve, a first insulating ring, a second insulating ring, a connector fixing member, a first spring, an elastic electrode connector, a connector positioning member, a second spring, a positive spring plate, a spring plate carrier, a control board, a first screw, a power button, a first silicon sleeve, a regulation button, a second silicon sleeve, a cover board of the regulation button, a second screw, and a second magnet of battery cover;
wherein
the first magnet is embedded in a slot of the main body via the press block; the main body comprises a screw thread on a top of the main body; the battery cover is connected to the main body; the electrode sleeve, the first insulating ring, the second insulating ring, and the connector fixing member are sheathed in the main body and then are compressed;
the first spring is sleeved on the elastic electrode connector and is connected to the connector positioning member; the first spring, the elastic electrode connector, and the connector positioning member are compressed in the main body; the second spring is disposed in the positive spring sheet, and the positive spring sheet is compressed in the spring plate carrier; the spring plate carrier with the positive spring sheet is inserted in a first hole on the control board, and is soldered to the control board; a printed circuit board on the control board comprises a main control IC unit and a control circuit; the main control IC unit is connected to the battery, display member, and the control circuit; the control circuit is adapted to control atomizer output; the main IC unit is connected to buttons and charging circuit; the charging circuit is connected to the battery;
the control board is mounted on the main body via the first screw; the first silicon sleeve is sleeved on the power button, and the second silicon sleeve is sleeved on the regulation button; the power button and the regulation button are mounted on the cover board of the regulation button; a screw post on the cover board of the regulation button is aligned with a second hole on the control board, and the cover board of the regulation button is mounted on the main body via the second screw; and
the second magnet is embedded in a slot of the battery cover, and is riveted with the battery cover via the press block; and the main body is connected to the battery cover.

2. The battery box of claim 1, wherein the battery box comprises five buttons with corresponding functions.

3. The battery box of claim 1, wherein the battery box comprises a safety lock; and the safety lock is changed or locked via a three-digit password.

4. The battery box of claim 1, wherein the battery box is named using ten lower and upper case letters on the battery box; the battery box is renamed by disconnecting to a computer.

5. The battery box of claim 2, further comprising a power regulation module.

6. The battery box of claim 1, further comprising a protection module.
